(19) United States
(12) Patent Application Publication
(10) Pub. No.: US 2025/0148192 A1
(43) Pub. Date: May 8, 2025

(54) GENERATING ALTERNATIVE EXAMPLES FOR CONTENT

(71) Applicant: Adobe Inc., San Jose, CA (US)

(72) Inventors: Simra SHAHID, Noida (IN); Nikitha SRIKANTH, Bangalore (IN); Surgan JANDAIL, Noida (IN); Balaji KRISHNAMURTHY, Noida (IN)

(21) Appl. No.: 18/501,745

(22) Filed: Nov. 3, 2023

(51) Int. Cl. G06F 40/166; G06F 16/9538; G06F 40/194

(52) U.S. Cl. CPC G06F 40/166; G06F 16/9538; G06F 40/194

(57) ABSTRACT

Methods, computer systems, computer-storage media, and graphical user interfaces are provided for efficiently generating alternative examples for content. In embodiments, a source example prompt is obtained at a large language model. The source example prompt includes text associated with a source content and an instruction to generate a source example from the text associated with the source content. Using the large language model, the source example that represents an entity and corresponding context from the text is generated. Thereafter, the source example and a set of user segments are provided as input into the large language model to generate alternative examples associated with the source content. Each alternative example corresponds to a user segment of the set of user segments. Based on a particular user segment associated with a user interested in the source content, an alternative example corresponding to the particular user segment is provided for display.

### BACKGROUND

Efforts have been made to personalize text-based content for different users such that it is more desirable to review. Such efforts to personalize text-based content for different users have generally included adapting textual style, such as words, tone, and vocabulary. Adapting textual style, however, generally does not sufficiently resonate with a user's specific interests. As such, modifying content to tailor the content to different user segments can be valuable as content tailored for an individual may be more engaging, or of interest, to users.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating efficient generation of alternative examples for content. In this regard, alternative examples are efficiently and effectively generated in an automated manner such that the alternative examples can be viewed, for example, in association with the original content. Such alternative examples generally convey examples that are alternative to, or different from, an example provided in the original content. As described herein, alternative examples are generated for different user segments. Accordingly, a user can view an alternative example that corresponds with a user segment of interest to the user. For example, a user interested in technology can view a technology-related example that corresponds with, or matches, context in the original content. The technology-related example can be provided supplemental to the original content, or the original content can be modified to include the technology-related example.

### BRIEF DESCRIPTION OF THE DRAWINGS

The technology described herein is described in detail below with reference to the attached drawing figures, wherein:

FIG. 1 is a block diagram of an exemplary system for facilitating efficient generation of alternative examples for content, suitable for use in implementing aspects of the technology described herein;

FIG. 2 is an example implementation for facilitating efficient generation of alternative examples for content, in accordance with aspects of the technology described herein;

FIGS. 3A-3B provide an example implementation for generating alternative examples for content, in accordance with embodiments of the present technology;

FIGS. 4A-4B provide example graphical user interfaces for presenting alternative examples, in accordance with embodiments of the present technology;

FIG. 5 provides an example implementation for generating alternative examples for content, in accordance with embodiments of the present technology;

FIG. 6 provides another example implementation for generating alternative examples for content, in accordance with aspects of the technology described herein;

FIG. 7 provides an example implementation for verifying generated alternative examples, in accordance with aspects of the technology described herein; and

FIG. 8 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Content is generally recognized as more valuable when it resonates with the audience's unique interests. Accordingly, efforts have been made to personalize text-based content for different users. Such efforts to personalize text-based content for different users has generally included adapting textual style, such as words, tone, and vocabulary. Efforts to adapt textual style, however, often do not sufficiently resonate with a user's specific interests. As such, modifying content to tailor the content to different user segments can be valuable as content tailored for an individual may be more engaging, or of interest, to users. Customizing content, however, is generally tedious and time-consuming.

In some conventional implementations, content creation processes include the manual generation of several content variants, with each variant being tailored to a different user segment or preference. In addition to such an implementation being labor-intensive and time-consuming, it lacks the precision necessary to achieve individualized personalization. Further, unnecessary computing resources are used to generate the different content, test or validate the varied content, and modify the content as needed. As can be appreciated, these inefficiencies increase as the number of customizations increase (e.g., to target an extensive number of user segments or interests). For instance, an extensive number of user preferences and corresponding examples results in a tedious process to manually perform content research for all user preferences.

With advancements in technology, some conventional implementations include content recommendation algorithms that suggest distinct content based on user behavior and preferences. Such systems, however, do not alter content itself to better suit the reader of the content, thereby missing out on opportunities to increase user engagement. As such, computing resources may be unnecessarily used to provide recommendations that do not enhance engagement with the reader. Moreover, a user may increase computing resource usage by further searching for desired content that aligns with the user's interests.

Accordingly, embodiments of the present technology are directed to efficient and effective generation of alternative examples for content. In this regard, alternative examples for content are efficiently and effectively generated in an automated manner such that the alternative examples can be viewed in accordance with an interest of a user. Generally, as described herein, alternative examples include examples that are alternative to a source example identified in the content. The alternative examples generally correspond to different user segments. In this way, an alternative example is tailored for the viewer such that the viewer is presented with an alternative example corresponding to a user segment associated with the viewer. As such, embodiments described herein provide a content personalization strategy that focuses on identifying and customizing examples within content to match or correspond to a user's segment(s) (e.g., based on interests, demographics, etc.). Advantageously, existing content is aligned with a user's interests without necessitating the continual creation and review of new content, which is a costly and time-consuming process. Personalizing or aligning content, such as examples, with a user's interests enhances both the overall content relevance and user engagement with the content.

By way of example only, assume an article discusses a “first-mover advantage” of businesses. Further assume the article uses many highly technical examples, such as Magnavox Odyssey or Osborne 1. Such examples, however, may not resonate with readers from other industries, such as food, entertainment, and travel. Further, such examples are not contemporarily relevant for various demographic groups, as the Magnavox Odyssey narrative is from 1972. Accordingly, many readers may be more engaged if the article included relatable examples and/or current examples. As such, embodiments described herein enable automated identification of source examples, that is, examples within an original content and utilization of the source examples to generate alternative examples that correspond to different topics. In this way, in association with a user accessing the content, an alternative example(s) that resonates more with the user (e.g., based on a user interest of a topic) can be presented to the user.

Generating alternative examples in an automated manner, as described herein, reduces computing resources otherwise utilized to manually generate or prepare training data and/or search for desired content. For example, content does not need to be downloaded and viewed to identify particular information about the content in order to manually generate annotations for training data such that content can be customized for users. As another example, computing resources used to manually locate and review desired content are not needed. For instance, assume a user is generally interested in a content item. Using embodiments described herein, an example alternative to one provided in the original content that corresponds to an interest of the user can be provided in association with the content, such that the user does not need to search for other examples that are more relevant or engaging to the user. In this way, a potential consumer is presented with tailored examples associated with the content, thereby reducing the additional computing resources consumed from a user otherwise searching for such information (e.g., by performing a search).

In operation, to efficiently and effectively generate alternative examples, a source example is identified from particular content (also referred to herein as source content). A source example generally refers to an example within content that can be used to generate alternative examples. In some cases, a source example may be represented in the form of an entity-context pair. In this regard, an entity is identified within the content and context surrounding the entity is identified. As described in association with embodiments described herein, a machine learning model, which may be in the form of a large language model (LLM), is used to identify a source example in an automated manner. Thereafter, the identified source example (e.g., entity-context pair) can be used to generate an alternative example(s) associated with the content. In embodiments, alternative examples are generated via a machine learning model in the form of an LLM. In particular, the source example and a set of user segments (e.g., in addition to context with the source example mention) are provided as input into the LLM and, in response, the LLM provides one or more alternative examples. For instance, at least one alternative example may be generated for each user segment. In this way, different examples are generated for different user segments of interest. Accordingly, examples can be presented in accordance with content that is tailored to a user based on a user segment(s) associated with the user. By way of example only, a user interested in entertainment can be presented with an example corresponding to the entertainment industry, and a user interested in sports can be presented with an example corresponding to the sports industry.

In this regard, aspects of the technology described herein facilitate generating a model prompt(s) to input into an LLM to attain a desired output in the form of a source example(s) and/or an alternative example(s). For example, for a particular content item, a model prompt is programmatically generated and used to facilitate output in the form of a source example. The model prompt may be based on content in the form of text, which can be obtained and/or selected for generating the model prompt. Further, a model prompt is programmatically generated and used to facilitate output in the form of alternative examples. Such a model prompt includes, for example the generated source example and any number of user segments. Using technology described herein, alternative examples can be generated to correspond with different or varied user segments to provide a variety of examples for use in providing tailored examples in association with content. An alternative example(s) can, thereafter, be presented to a user in association with that content, such that the content is tailored to interests of the user, thereby resulting in content that resonates with the user.

Advantageously, using an LLM to generate source examples and/or alternative examples facilitates reducing computing resource consumption, such as computer memory and latency. In particular, source examples and alternative examples can be accurately generated without requiring training and/or fine-tuning of the model. Utilizing pre-trained models reduces computing resources consumed for performing training. For example, there is a lack of annotated training datasets to perform content adaption. As such, to train supervised learning models, human annotations would need to be generated, which would be time-consuming and resource-intensive due to the need to generate training datasets needed to achieve models with usable performance. Fine-tuning refers to the process of re-training a pre-trained model on a new dataset without training from scratch. Fine-tuning typically takes weights of a trained model and uses those weights as the initialization value, which is then adjusted during fine-tuning based on the new dataset. Particular embodiments described herein do not need to engage in fine-tuning by ingesting millions of additional data sources and billions of parameters and hyperparameters. As such, the models of various embodiments described herein are significantly more condensed. In accordance with embodiments described herein, the models do not require as much computational and memory requirements because there is no need to access the billions of parameters, hyperparameters, or additional resources in the fine-tuning phase. As described, all of these parameters and resources must typically be stored in memory and analyzed at runtime and fine-tuning to make predictions, making the overhead extensive and unnecessary.

Further, various embodiments take significantly less time to train and deploy in a production environment because the various embodiments can utilize a pre-trained model that does not require fine-tuning. Accordingly, embodiments can utilize pre-trained models without requiring fine-tuning. Another technical solution is utilizing the content and/or source examples as an input prompt for the machine learning model as a proxy to fine-tuning. Further, human-annotated samples are not needed for training, fine-tuning, or including in a model prompt to generate a source example and/or alternative examples. As such, embodiments described herein improve computing resource consumption, such as computer memory and latency, at least because not as much data (e.g., parameters) is stored or used for producing the model output and computational requirements otherwise needed for fine-tuning are not needed.

### Overview of Exemplary Environments for Generating Alternative Examples for Content

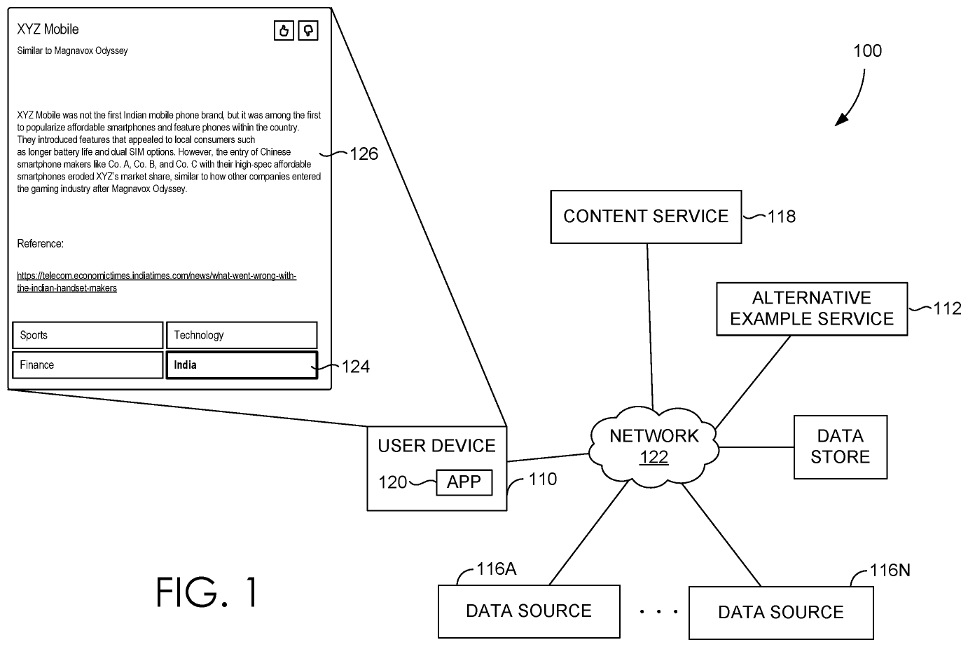

Referring initially to FIG. 1, a block diagram of an exemplary network environment 100 suitable for use in implementing embodiments described herein is shown. Generally, the system 100 illustrates an environment suitable for facilitating generation of alternative examples for content. Among other things, embodiments described herein efficiently generate alternative examples for content. An alternative example generally refers to an example or instance that is different from that provided in a source or original content. As described herein, an alternative example is generally provided in association with a user segment. Advantageously, generating and providing an alternative example associated with particular content (e.g., an article) in an efficient manner enables a user associated with a user segment (e.g., interested in a particular topic) to have a better understanding of, and interest in, the content without having to manually track down the desired data using various systems and queries thereto.

The network environment 100 includes user device 110, an alternative example service 112, a data store 114, data sources 116a-116n (referred to generally as data source(s) 116), and a content service 118. The user device 110, the alternative example service 112, the data store 114, the data sources 116a-116n, and content service 118 can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data sources 116a-116n may be in communication with the alternative example service 112 and/or the content service 118 via a mobile network or the Internet, and the alternative example service 112 and/or content service 118 may be in communication with data store 114 via a local area network. Further, although the environment 100 is illustrated with a network, one or more of the components may directly communicate with one another, for example, via HDMI (high-definition multimedia interface), and DVI (digital visual interface). Alternatively, one or more components may be integrated with one another. For example, at least a portion of the alternative example service 112 and/or data store 114 may be integrated with the user device 110, data sources 116, and/or content service 118. For instance, a portion of the alternative example service 112 may be integrated with a user device, while another portion of the alternative example service 112 may be integrated with a content service 118.

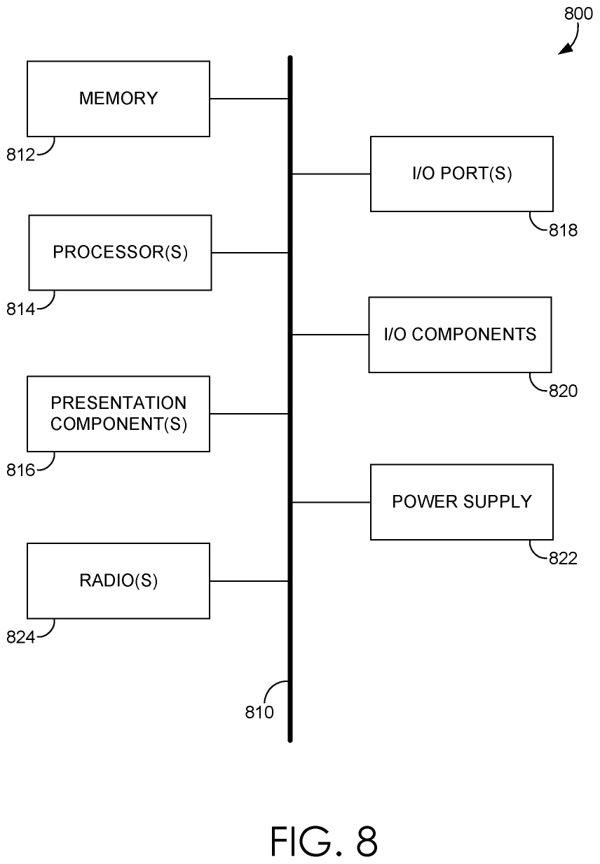

The user device 110 can be any kind of computing device capable of facilitating generating and/or providing alternative examples. For example, in an embodiment, the user device 110 can be a computing device such as computing device 800, as described above with reference to FIG. 8. In embodiments, the user device 110 can be a personal computer (PC), a laptop computer, a workstation, a mobile computing device, a PDA, a cell phone, or the like.

The user device can include one or more processors, and one or more computer-readable media. The computer-readable media may include computer-readable instructions executable by the one or more processors. The instructions may be embodied by one or more applications, such as application 120 shown in FIG. 1. The application(s) may generally be any application capable of facilitating generating and/or providing alternative examples for content. In some implementations, the application(s) comprises a web application, which can run in a web browser, and could be hosted at least partially server-side (e.g., via a server). In addition, or instead, the application(s) can comprise a dedicated application. In some cases, the application is integrated into the operating system (e.g., as a service).

User device 110 can be a client device on a client-side of operating environment 100, while alternative example service 112 and/or content service 118 can be on a server-side of operating environment 100. Alternative example service 112 and/or content service 118 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110, alternative example service 112, and/or content service 118 remain as separate entities.

In an embodiment, the user device 110 is separate and distinct from the alternative example service 112, the data store 114, the data sources 116, and the content service 118 illustrated in FIG. 1. In another embodiment, the user device 110 is integrated with one or more illustrated components. For instance, the user device 110 may incorporate functionality described in relation to the alternative example service 112 and/or content service 118. For clarity of explanation, embodiments are described herein in which the user device 110, the alternative example service 112, the data store 114, the data sources 116, and the content service 118 are separate, while understanding that this may not be the case in various configurations contemplated.

As described, a user device, such as user device 110, can facilitate generating and/or providing alternative examples for content. A user device 110, as described herein, is generally operated by an individual or entity that may initiate generation and/or that views alternative examples(s). In some cases, such an individual may be, or be associated with, a contributor, manager, developer, or creator of the content (e.g., a text content, such as an article, being analyzed to generate alternative examples). In this regard, the user may be interested in alternative examples, for example, to understand how to enhance or improve the content, to understand how to market or advertise the content, to provide in relation to the content, etc. In other cases, an individual or entity operating the user device may be an individual associated with a content service, that is, a service that facilitates generation and/or presentation of content (e.g., text content such as articles). For example, a user may be interested in alternative examples to provide better or more relevant results or language for a viewer of the content. In yet other cases, such an individual may be a person interested in, or a consumer of, content or alternative examples associated therewith. For example, an individual may navigate to view an article (e.g., included as a search result). Based on navigating to view the article, and/or searching for the particular article, the user may be provided with an alternative example(s) associated with the article. In this way, the viewer of the article may be presented with additional examples related to the content that can be valuable or interesting to the viewer. Alternatively or additionally, the user may not need to read the article based on the presentation of the alternative example(s).

In some cases, generating or providing of alternative examples may be initiated at the user device 110. For example, in some cases, a user may directly or expressly select to generate or view an alternative example(s) related to content. For instance, a user desiring to view alternative examples associated with an electronic document, such as an article, may specify a desire to view an alternative example. To this end, a user of the user device 110 that initiates generating and/or providing of an alternative example(s) may be a user that performs some aspect of content creation, marketing, or the like (e.g., via a link or query). As another example, a user desiring to view an alternative example(s) may select a link or icon to view an alternative example associated with content. In other cases, a user may indirectly or implicitly select to generate or view an alternative example(s) related to content. For instance, a user may navigate to a content store application or website. Based on the navigation to the content store application or website, the user may indirectly indicate to generate or view an alternative example(s) associated with content(s). In some cases, such an indication may be based on generally navigating to the application or website. For instance, an alternative example(s) may be requested for each electronic document (e.g., article) to be, or that may be, presented in the application or website. In other cases, such an indication may be based on selecting a particular content item to view or hovering over a particular content portion to indicate interest. In yet another example, a user of the user device 110 that initiates generating and/or providing of an alternative example(s) may be a user corresponding to a content service. For instance, a content service that hosts various content (e.g., for presenting, searching, or storing) may desire to generate alternative examples for a set of content. In this way, the user may select one content or a batch of content and, thereafter, select to generate alternative examples associated with the selected content(s). In other embodiments, initiation of alternative contents may be automatically triggered or initiated. For instance, upon a content service obtaining a particular number of new content items (e.g., electronic documents), generation of alternative examples associated with the new content can be automatically triggered.

Generating and/or providing an alternative example(s) may be initiated and/or presented via an application 120 operating on the user device 110. In this regard, the user device 110, via an application 120, might allow a user to initiate generation or presentation of an alternative example(s). The user device 110 can include any type of application and may be a stand-alone application, a mobile application, a web application, or the like. In some cases, the functionality described herein may be integrated directly with an application or may be an add-on, or plug-in, to an application. One example of an application that may be used to initiate and/or present alternative examples includes any application in communication with a content service, such as content service 118.

Content service 118 may be any service that provides, stores, and/or presents content, such as text content (e.g., electronic documents, articles, etc.). By way of example, a content service may include a content store, a search engine, a content data store, an advertisement or marketing service, or the like. In some of these examples, the content service provides content (e.g., for viewing or consumption) and can include alternative examples associated with the content. For example, a content service may be or include a content search results service that provides various content for viewing. An individual may select to view, purchase, or obtain a content or set of content. In the content offering, the content service includes or provides a corresponding alternative example(s), such that the examples can be used to understand the content or be more aligned with interests of the individual.

Although embodiments described above generally include a user or individual inputting or selecting (either expressly or implicitly) to initiate or view an alternative example(s) for content, as described below, such initiation may occur in connection with a content service, such as content service 118, or other service or server. For example, content service 118 may initiate generation of alternative examples on a periodic basis. Such alternative examples can then be stored and, thereafter, accessed by the content service 118 to provide to a user device for viewing (e.g., based on a user navigating to particular content, for instance, in a content store, a content search, etc.).

The user device 110 can communicate with the alternative example service 112 and/or content service 118 to initiate generation or viewing of an alternative example(s) for content. In embodiments, for example, a user may utilize the user device 110 to initiate generation of alternative examples via the network 122. For instance, in some embodiments, the network 122 might be the Internet, and the user device 110 interacts with the alternative example service 112 (e.g., directly or via another service such as the content service 118) to initiate generation of alternative examples. In other embodiments, for example, the network 122 might be an enterprise network associated with an organization. It should be apparent to those having skill in the relevant arts that any number of other implementation scenarios may be possible as well.

With continued reference to FIG. 1, the alternative example service 112 can be implemented as server systems, program modules, virtual machines, components of a server or servers, networks, and the like. At a high level, the alternative example service 112 manages generation of alternative examples associated with context. In particular, the alternative example service 112 can obtain or generate various source examples associated with content, such as a text document, an article, and/or the like. A source example generally refers to an example identified in a source or original content. A source example may be identified or generated in a form including an entity and corresponding context. In this regard, the source example may be included in the content and need not be specified or indicated as an example. Using text content, or portion thereof, the alternative example service 112 can generate a model prompt to initiate generation of a source example. As one example, a model prompt may include text extracted from an article or electronic document. The model prompt can be input into an LLM to obtain, as output, a source example (e.g., an entity-context pair). In some cases, content used as a basis for generating a source example may correspond to data provided via data sources 116. Data sources 116a-116n may be any type of computing devices at which content may be generated or stored. For example, upon an individual creating an article via a data source 116, the individual may provide the article for use, searching, viewing, and/or analysis. The content provided may be provided by the data source 116 (e.g., to the content service 118 that collects content), for example, for subsequent presentation to potential consumers.

In accordance with generating a source example, the alternative example service 112 generates one or more alternative examples. As described herein, alternative examples may be generated in accordance with any number of user segments. For example, one or more alternative examples may be generated for five different user segments (e.g., topics). In this way, alternative examples are generated that may correspond to different user's interests. To generate alternative examples, an LLM can be used, in some embodiments. As such, a prompt may be generated that includes a source example, a set of user segments of interest, and an instruction to generate an alternative example(s) for each user segment based on the source example.

In accordance with generating an alternative example(s), the alternative example service 112 outputs one or more alternative examples. In some cases, the alternative example service 112 outputs an alternative example(s) to user device 110. By way of example, assume a user of user device 110 is viewing particular content (not shown) via application 120 operating on user device 110. Further assume the user is interested in, and selects, the India 124 user segment via a graphical user interface that presents a set of user segment options. In such a case, an alternative example 126 associated with the particular content and tailored to the India user segment is provided to the user device 110 for presentation.

In other cases, the alternative example service 112 outputs an alternative example(s) to another service, such as content service 118, or a data store, such as data store 114. For example, upon generating an alternative example, the alternative example can be provided to content service 118 and/or data store 114 for subsequent use. For instance, when a user subsequently views the particular content via application 120 on user device 110, the content service 118 may provide an alternative example associated with the particular content to the user device. In yet other cases, an alternative example(s) may be provided for analysis of the content. Any number of uses of such alternative examples may be implemented in accordance with embodiments described herein.

As described, the content service 118 may be any service that provides, presents, or analyzes content. By way of example, a content service may include a content store, a content search service, a content datastore, a content analysis service, a content creation service, or the like. In these examples, the content service can provide alternative example(s) associated with the content. In this regard, the content service 118 may communicate with user device 110, for example, via application 120, to present various content and/or corresponding alternative examples for display. For instance, content service 118 may communicate with application 120 operating on user device 110 to provide back-end services to application 120.

As can be appreciated, in some cases, the alternative example service 112 may be a part of, or integrated with, the content service 118. In this regard, the alternative example service 112 may function as a portion of the content service 118. In other cases, the alternative example service 112 may be independent of, and separate from, the content service 118. Any number of configurations may be used to implement aspects of embodiments described herein.

Advantageously, utilizing implementations described herein enable generation and presentation of alternative examples corresponding to content to be performed in an efficient manner. Further, the alternative examples provide examples associated with different user segments, such that an example suitable to a user's interest can be viewed in association with a content item. As such, more relevant information for a user, in addition to or in the alternative to an original example, or source example, can be viewed, thereby facilitating more effective understanding and resonance of content.

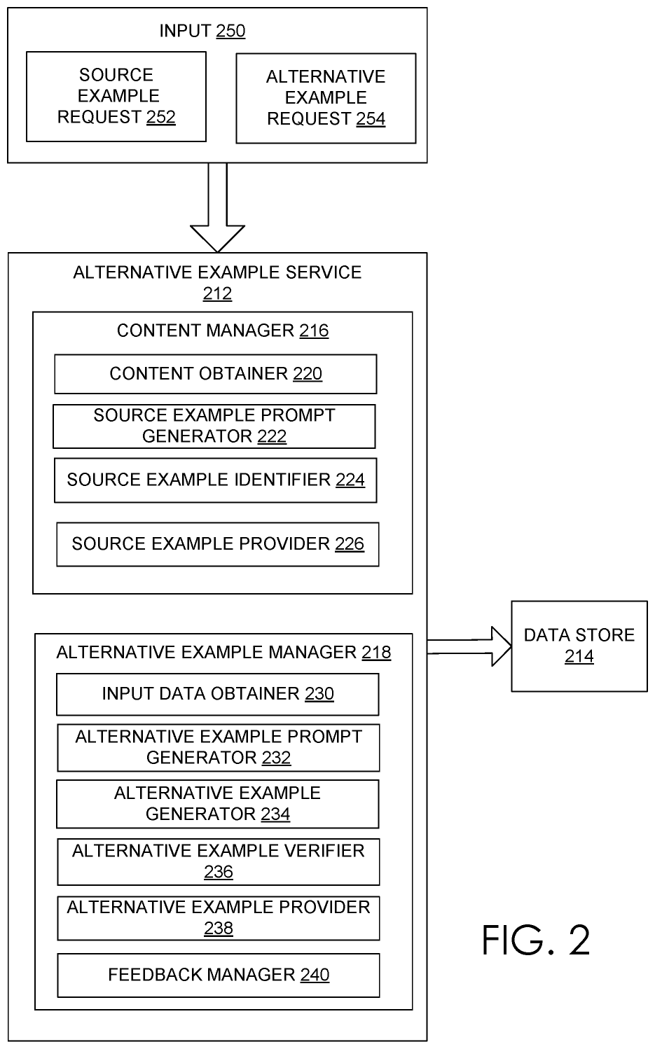

Turning now to FIG. 2, FIG. 2 illustrates an example implementation for generating and/or providing alternative examples associated with content via alternative example service 212. The alternative example service 212 can communicate with the data store 214. The data store 214 is configured to store various types of information accessible by the alternative example service 212 or other server or service. In embodiments, user devices (such as user devices 110 of FIG. 1), data sources (such as data sources 116 of FIG. 1), a content service (such as content service 118 of FIG. 1), and/or servers or services can provide data to the data store 214 for storage, which may be retrieved or referenced by any such component. As such, the data store 214 may store content, source examples, alternative examples, user segments, user profiles, and/or the like. In this regard, data store 214 may store identified source examples, which can then be accessed for subsequent use to generate alternative examples. The generated alternative examples may also be stored in data store 214, which can then be accessed for subsequent use, analysis, or display.

In operation, the alternative example service 212 is generally configured to manage generation and/or provision of alternative examples for content. In embodiments, the alternative example service 212 includes a content manager 216 and an alternative example manager 218. The content manager 216 is generally configured to manage content data (e.g., identify source examples), and the alternative example manager 218 is generally configured to manage generation of alternative examples. According to embodiments described herein, the alternative example service 212 can include any number of other components not illustrated. In some embodiments, one or more of the illustrated components 216 and 218 can be integrated into a single component or can be divided into a number of different components. Components 216 and 218 can be implemented on any number of machines and can be integrated, as desired, with any number of other functionalities or services.

In embodiments, the content manager 216 includes a content obtainer 220, a source example prompt generator 222, a source example identifier 224, and a source example provider 226. According to embodiments described herein, the content manager 216 can include any number of other components not illustrated. In some embodiments, one or more of the illustrated components 220, 222, 224, and 226 can be integrated into a single component or can be divided into a number of different components. Components 220, 222, 224, and 226 can be implemented on any number of machines and can be integrated, as desired, with any number of other functionalities or services.

As described, the content manager 216 is generally configured to manage content data. Content data generally refers to any data associated with content. Generally, the content described herein is text content and can be in any electronic or digital form. For example, content may be an article in the form of an electronic document.

The content manager 216 may receive input 250 to initiate generation and/or provision of a source example and/or an alternative example(s). Input 250 may include a source example request 252. A source example request 252 generally includes a request or indication to generate a source example(s) associated with content. A source example request may specify, for example, an indication of content(s) for which a source example and/or alternative example is desired, an indication of a set of user segments to use for generating an alternative example(s), and/or the like.

A source example request 252 may be provided by any service or device. For example, in some cases, a source example request 252 may be initiated and communicated via a user device, such as user device 110 of FIG. 1. For example, assume a user accesses a website or an application having one or more text documents associated therewith (e.g., presented via the website or application). In such a case, a source example request 252 may be initiated that includes a request to generate a source example(s) and/or an alternative example(s) associated with a particular set of text documents. For instance, in one example, the source example request 252 may specify each text document associated with the website or application. In another example, the source example request 252 may specify a particular set of text documents for which a source example(s) and/or an alternative example(s) is desired, such as the text documents initially presented via the application or website, or a text document selected or otherwise identified in association with a user interest (e.g., a user pauses scrolling over the text document or selecting the text document to view). In another example, a user may be an individual or entity associated with a particular set of content (e.g., a creator of text documents). In such a case, the user may select to view source examples and/or alternative examples associated with the particular content(s) such that the user can obtain constructive insights related to the content. In this way, the user may view the source examples and/or alternative examples to identify opportunities to improve or enhance the content.

Alternatively or additionally, a source example request 252 may be initiated and communicated via a user device or administrator device, such as an administrator device associated with content service 118 of FIG. 1. For example, assume a content service 118 provides a website that enables presentation of various text content. An administrator of the website may initiate a source example request 252 to generate source examples and/or alternative examples associated with such content. Such source examples and/or alternative examples may be stored for later presentation to users. In other cases, a source example request 252 may be automatically initiated and communicated via a service, such as content service 118 of FIG. 1. For example, a website or application service, such as content service 118, associated with content may automatically initiate generation of source and/or alternative examples, for instance, based on a lapse of a time period, a reception of a set of content (e.g., upon obtaining a predetermined number of text documents), or other criteria. As can be appreciated, the automated initiation of source and/or alternative examples may be dynamic, for instance, based on attributes associated with the content. For example, in cases in which content items are more frequently obtained or viewed, a request may be initiated more frequently, whereas when content is less frequently obtained or reviewed, the request for alternative example generation may be initiated less frequently.

As described herein, although source example request 252 and alternative example request 254 are illustrated separately, in embodiments, a single request may be used. Further, although not illustrated, input 250 may include other information communicated in association with a request. For example, and as described below as one implementation, content, or a reference thereto (e.g., a link to content or uniform resource locator (URL) associated with content), a desired user segment or set of user segments to use for generating alternative examples, etc., may be provided in association with the request. For instance, in some cases, an administrator may provide an indication of a content item and a set of user segments, which is communicated in association with a request to initiate generation of an alternative example(s).

The content obtainer 220 is generally configured to obtain content. In this regard, in some cases, the content obtainer 220 obtains content in accordance with obtaining a request, such as source example request 252. Content generally refers to any data in the form of electronic text that is used to generate a source example and/or alternative example(s). In this regard, content may include, but is not limited to, an electronic document, an article, a description, a form, and/or the like.

In some cases, the content obtainer 220 can obtain content from various sources for utilization in determining source and/or alternative examples. As described above, in some cases, content may be obtained as input 250 along with the source example request 252. For example, in some implementations, a user (e.g., an administrator) may input or select content in the form of text, or a portion thereof, via a graphical user interface for use in generating source and/or alternative examples. For instance, a user, operating via a user device, desiring to view a source and/or alternative example, may select or input a set of text or content for use in generating corresponding source and/or alternative examples. As another example, a marketer or other individual may provide a list of URLs that includes content intended for generation of source and/or alternative examples.

Additionally or alternatively, the content obtainer 220 may obtain content from any number of sources, such as data sources 116 of FIG. 1, or data stores, such as data store 214. In this regard, in accordance with initiating generation of a source and/or alternative example, the content obtainer 220 may communicate with a data store(s) or other data source(s), including a content service (e.g., content service 118 of FIG. 1) and obtain content, or text, to generate a source and/or alternative example(s). For example, in accordance with an indication or specification of the particular content, the text associated with the particular content can be accessed and obtained. Data store 214 illustrated in FIG. 2 may include such content or text, but any number of data stores and/or data sources may provide various types of content. Such data stores and data sources may include public data, private data, and/or the like. For instance, a website service may store data associated with various content, including articles, research papers, advertisements, descriptions, etc.

In some embodiments, the content obtainer 220 may obtain content by facilitating identifying, generating, or extracting such content. In this way, the content obtainer 220 may include or access components that identify, generate, or extract content or text. In embodiments, the content obtainer 220 can facilitate generation of text data from various forms or modalities of data. Various types of algorithms, machine learning, models, etc. may be employed to identify, generate, or extract content in the form of text, some of which are described herein to provide examples.

One example of text content that may be identified or generated is audio transcription. In some cases, an audio transcription may be generated for an audio (e.g., in a video). As such, one technology that may be used to generate an audio transcription is automatic speech recognition. In this way, automatic speech recognition may be used to extract audio from a file and generate a text version of the audio. Generally, automatic speech recognition recognizes and transcribes spoken language into text. In embodiments, automatic speech recognition systems use machine learning to analyze audio signals and convert them into text.

Another example is performing text extraction to obtain content. Accordingly, in embodiments, the content obtainer 220 may facilitate, reference, or use technology that extracts text. As one example, for a given URL (e.g., provided by a marketer), text content associated with the URL can be extracted. To extract textual information, one technology that may be used is optical character recognition (OCR).

The content obtainer 220 may obtain any type and/or amount of content, or text data. For example, in some cases, an entire set of text may be obtained. In other cases, text data associated with only a portion of the content (e.g., a summary or abstract) may be obtained. The type and amount of content obtained by content obtainer 220 may vary per implementation and is not intended to limit the scope of embodiments described herein.

The source example prompt generator 222 is generally configured to generate source example prompts. As used herein, a source example prompt or model prompt generally refers to an input, such as a text input, that can be provided to source example identifier 224, such as an LLM, to generate an output in the form of a source example(s). As described herein, a source example generally refers to an example identified from the content for which an alternative example(s) is generated. In embodiments, a source example prompt generally includes text to influence a machine learning model, such as an LLM, to generate text having a desired content and structure. A model prompt typically includes text given to a machine learning model to be completed. In this regard, a model prompt generally includes instructions and, in some cases, examples of desired output. A model prompt may include any type of information. In accordance with embodiments described herein, a model prompt may include various types of text data. In particular, a model prompt generally includes text data corresponding to content.

In embodiments, the source example prompt generator 222 is configured to select a set of content or text for which to use to generate a source example(s). For example, assume a source example is to be generated for a particular content and text data associated with the content is obtained. In such a case, the source example prompt generator 222 may select a particular set of text data to use for generating a corresponding source example(s). In this way, the source example prompt generator 222 may select a set of text data from the entire content data.

Text data for the source example model prompt may be selected based on any number or type of criteria. As one example, text data may be selected to be under a maximum number of tokens required by a source example identifier, such as an LLM. For example, assume an LLM includes a 5,000 token limit. In such a case, text data totaling less than the 5,000 token limit may be selected. Such text data selection may be based on, for example, a location or position in an electronic document. For instance, text data associated with a summary or abstract may be selected over citations or results portions of the document.

Other types of information to include in a source example model prompt may include an instruction to generate a source example, user data associated with a user viewing, or to view, the content and/or alternative examples, and/or the like, depending on the desired implementation or output. In accordance with embodiments herein, the instruction can specify to generate one or more source examples for the provided or corresponding content. As described, a source example refers to an example provided within the source or original content. In one embodiment, a source example includes an entity(s) and corresponding context(s). In such cases, an LLM can be instructed to identify a set of entities (e) and their associated contexts (c) associated with text content t[i] as follows: [e₁, c₁]; [e₂, c₂]; [e₃, c₃], . . . [eₙ, cₙ]=LLM (t[i]). In some cases, a sample example may be provided in the source example model prompt. In this way, the LLM may use the sample example as reference for generating a source example provided within the content. For example, a sample entity may be provided in the source example prompt. In this way, the LLM may use the sample entity as reference for identifying an entity from source content. Additionally or alternatively, a sample context associated with a sample entity may be identified and provided in a source example prompt, such that the LLM may use the sample context as reference for identifying context from source content.

In addition, a source example model prompt may also include output attributes. Output attributes generally indicate desired aspects associated with an output, such as a source example. For example, an output attribute may indicate a target temperature to be associated with the output. A temperature refers to a hyperparameter used to control the randomness of predictions. Generally, a low temperature makes the model more confident, while a higher temperature makes the model less confident. Stated differently, a higher temperature can result in more random output, which can be considered more creative. On the other hand, a lower temperature generally results in a more deterministic and focused output. A temperature may be a default value, a value based on user input, or a determined value (e.g., based on a content attribute, such as the length of a content or a type of content). As another example, an output attribute may indicate a length of output. For example, a source example model prompt may include an instruction for a desired number of paragraphs or sentences (e.g., in association with the context). As another example, a source example model prompt may include an instruction for a maximum number of characters or a target range of characters. As another example, an output attribute may indicate a target language for generating the output. For example, the text data may be provided in one language, and an output attribute may indicate to generate the output in another language. Any other instructions indicating a desired output is contemplated within embodiments of the present technology.

The source example prompt generator 224 may format the text data and output attributes in a particular form or data structure. One example of a data structure for a model prompt is as follows:

```
  { Instruction to Generate a Source Example (e.g., Identify all entities
and corresponding examples within the provided content, and note the
context in which these examples appear)
  { Source Content
  { Output Attributes (e.g., Please format the output as follows:
    Entity:
    Context:)
    { Temperature
```

As described, in embodiments, the source example prompt generator 222 generates or configures model prompts in accordance with size constraints associated with a machine learning model. As such, the source example prompt generator 222 may be configured to detect the input size constraint of a model, such as an LLM or other machine learning model. Various models are constrained by a data input size they can ingest or process due to computational expenses associated with processing those inputs. For example, a maximum input size of 14096 tokens can be programmatically set. Other input sizes may not necessarily be based on token sequence length, but other data size parameters, such as bytes. Tokens are pieces of words, individual sets of letters within words, spaces between words, and/or other natural language symbols or characters (e.g., %, $, !). Before a language model processes a natural language input, the input is broken down into tokens. These tokens are not typically parsed exactly where words start or end-tokens can include trailing spaces and even sub-words. Depending on the model used, in some embodiments, models can process up to 4097 tokens shared between prompt and completion. Some models (e.g., Generative Pre-trained Transformer, such as GPT-3) takes the input, converts the input into a list of tokens, processes the tokens, and converts the predicted tokens back to the words in the input. In some embodiments, the source example prompt generator 222 detects an input size constraint by simply implementing a function that calls a routine that reads the input constraints.

As described, the source example prompt generator 222 can determine which data, for example, obtained by the content obtainer 220 is to be included in the model prompt. In some embodiments, the source example prompt generator 222 takes as input the input size constraint and the text data to determine what and how much data to include in the model prompt. By way of example only, assume a source example model prompt is being generated in relation to a particular content. Based on the input size constraint, the source model prompt generator 222 can select which text of the content to include in the model prompt. As described, such a data selection may be based on any of a variety of aspects. As one example, the source example prompt generator 222 can first call for the input size constraint of tokens. Responsively, the source example prompt generator 222 can then tokenize each of the text data candidates to generate tokens, and then responsively and progressively add each text data ranked/weighted from highest to lowest if and until the token threshold (indicating the input size constraint) is met or exceeded, at which point the source example prompt generator 222 stops.

The source example prompt generator 222 may generate any number of model prompts. As one example, an individual source example prompt may be generated for a particular content. In this way, a one-to-one model prompt may be generated for a corresponding item. As such, text associated with the particular content is included in the source example prompt. As another example, a particular source example prompt may be generated to initiate source examples for multiple contents. For instance, a source example prompt may be generated to include an indication of a first content and corresponding text data, a second content and corresponding text data, and so on. As yet another example, a particular source example prompt may be generated to initiate a source example for a portion of a content. In this way, a source example is generated for a portion of a content, while other source examples may be generated for other portions of the content.

The source example identifier 224 is generally configured to identify or generate source examples. In this regard, the source example identifier 224 utilizes content in the form of text to generate a source example(s) associated with a content(s). In embodiments, the source example identifier 224 takes, as input, a source example prompt or set of source example prompts generated by the source example prompt generator 222. Based on the source example prompt, the source example identifier 224 can generate a source example or set of source examples associated with a content(s) indicated in the source example prompt. For example, assume a source example prompt includes a set of text associated with a content. In such a case, the source example identifier 224 generates a source example(s) associated with the particular content based on the set of text included in the source example prompt.

As described, a source example generally refers to an example provided within a source content or original content. The source example can represent or illustrate aspects that are, or are likely to be, imitated, reproduced, or representative of other information. A source example can be in any number of forms. In some embodiments, a source example can be an entity(s) and corresponding context(s), which may be referred to herein as an entity-context pair, or a set of entity-context pairs. In this regard, for a particular content, an LLM can output an identified entity and corresponding context. An entity generally refers to an aspect with distinct and independent existence. In embodiments, an entity refers to an aspect that is, or could be, relevant to a particular user segment. Context generally refers to aspects or circumstances that form a setting for the entity such that a source example can be recognized or identified. In this regard, context generally includes text that precedes, follows, and/or surrounds an entity. In this way, the entity and context include or provide a source example within the content.

The source example identifier 224 may be or include any number of machine learning models or technologies. In some embodiments, the machine learning model is a Large Language Model (LLM). A language model is a statistical and probabilistic tool that determines the probability of a given sequence of words occurring in a sentence (e.g., via next sentence prediction (NSP) or minimal learning machine (MLM)). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3, is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, a LLM generates representations of text, acquires world knowledge, and/or develops generative capabilities.

As such, as described herein, the source example identifier 224, in the form of a LLM, can obtain the model prompt and, using such information in the model prompt, generate a source example(s) for a content or set of contents. In some embodiments, the source example identifier 224 takes on the form of an LLM, but various other machine learning models can additionally or alternatively be used.

As described, any number of source examples can be generated for a content. For example, in one embodiment, an instruction to generate multiple (e.g., three) source examples may be provided in the model prompt. As another example, any number of source examples identified may be provided as output. As yet another example, any number of source examples that satisfy a threshold level of probability may be provided as output. As another example, source examples may be generated for different portions of the content. For instance, a first source example may be generated for a first content portion, and a second source example may be generated for a second content portion.

The source example provider 226 is generally configured to provide source examples. Generally, a source example(s) is provided for utilization, for example, to identify an alternative example(s) for the content, as described more fully below. In this regard, the source example provider 226 can provide a source example to alternative example manager 218 or store for utilization by the alternative example manager 218.

In some cases, upon generating a source example(s), the source example provider 226 can provide such data, for example, for display via a user device. To this end, in cases in which the alternative example service 212 is remote from the user device, the source example provider 226 may provide a source example(s) to a user device for display to a user interested in the content.

Alternatively or additionally, the source example may be provided to a data store for storage or another component or service, such as a content service (e.g., content service 118 of FIG. 1). Such a component or service may then provide the source example for display, for example, via a user device. For instance, as described herein, in some cases, source examples may be generated in a periodic manner. As one example, source examples may be generated for a set of content in off-hours (hours in which computing resources are more available and not used by other processes). Such source examples can then be stored, for example in data store 214. Thereafter, assume a user navigates, via a user device, to a website or application providing various content. In association with navigating to the website/application, or a particular content associated therewith, a content service can access an appropriate source example (e.g., corresponding with the particular content) and provide the source example for display in association with the corresponding content.

The source example may be provided for display in any number of ways. In some examples, the source example is provided in association with the corresponding content. For example, a content may be presented with corresponding data, including a source examples(s) associated therewith. In some cases, the source example is automatically displayed in association with the content. In other cases, a user may select to view the source example. For instance, a link may be presented that, if selected, presents the source example (e.g., integrated with the content, or provided in a separate window or pop-up text box).

Turning to the alternative example manager 218, the alternative example manager 218 is generally configured to generate alternative examples. In embodiments, the alternative example manager 218 includes an input data obtainer 230, an alternative example prompt generator 232, an alternative example generator 234, an alternative example verifier 236, an alternative example provider 238, and a feedback manager 240. According to embodiments described herein, the alternative example manager 218 can include any number of other components not illustrated. In some embodiments, one or more of the illustrated components 230, 232, 234, 236, 238, and 240 can be integrated into a single component or can be divided into a number of different components. Components 230, 232, 234, 236, 238, and 240 can be implemented on any number of machines and can be integrated, as desired, with any number of other functionalities or services.

The input data obtainer 230 may obtain or receive input data for use in generating one or more alternative examples. Input data generally refers to data used for generating an alternative example(s). In this regard, the input data obtainer 230 may obtain a source example to initiate generation and/or providing of an alternative example(s) in association with content. In some cases, the source example may be provided along with an alternative example request. In embodiments, an alternative example request 254 may be provided as input 250. An alternative example request generally includes a request or indication to identify a set of alternative examples, for example, in association with content, or a source example associated therewith. An alternative example request may include, for example, a source example, an indication of a source example, content, an indication of content, a set of user segments of interest, etc.

An alternative example request 254 may be provided by any service or device. For example, in some cases, an alternative example request 254 may be initiated and communicated via a user device, such as user device 110 of FIG. 1. For example, assume a user desires to use or view one or more alternative examples associated with a particular content. In such a case, an alternative example request 254 may be initiated that includes a request to identify an alternative example(s) associated with a content. As another example, an alternative example request 254 may be initiated and communicated via a content service. For instance, assume a user inputs a content search. To facilitate the search or review of search results, alternative examples associated with a search result may be desired and, as such, an alternative example request 254 may be generated. In one example, the alternative example request 254 may specify a set of one or more desired user segments (e.g., topics) for the alternative example(s). For instance, an alternative example request may specify a desire to identify an alternative example corresponding with a particular topic. Specific user interests for which to generate an alternative example(s) may be specified by a user, automatically determined, based on default values, etc. An alternative example request can be generated in any of a number of ways, including via an input or command, via selection of a link or button, and/or the like.

Alternatively or additionally, as described, an alternative example request may be automatically initiated and communicated to the input data obtainer 230. For example, a content service that uses alternative examples(s) (e.g., to analyze or present) may automatically initiate alternative example requests, for instance, based on input (e.g., a search query or selection to view a content) by a user, or other criteria. As can be appreciated, the automated initiation of an alternative example request may be dynamically determined, for instance, based on attributes associated with a content(s). As another example, upon generating a source example via the content manager 216, the source example provider 226 may provide an alternative example request to the input data obtainer 230 to initiate generation of one or more alternative examples associated with a content, or a source example corresponding therewith.

Although not illustrated, input 250 may include other information communicated in association with alternative example request 254. For example, the source example, or indication thereof, may be provided in association with the alternative example request. As another example, a set of user segments, such as topics, for which to generate alterative examples may be included in the alternative example request.

In cases in which an alternative example request 254 includes a content indicator, the input data obtainer 230 can obtain the corresponding source example(s) for use in generating an alternative example(s). For instance, an alternative example request may specify a content identifier (e.g., a URL). The input data obtainer 230 may then access a data store and lookup and obtain the source example(s) that corresponds with the content identifier.

The input data obtainer 230 can receive or obtain data from various sources for utilization in identifying an alternative example(s). As described above, in some cases, data may be obtained as input 250 along with an alternative example request 254. In other cases, data may be obtained from the content manager 216 and/or data store 214. Further, the input data obtainer 230 may obtain input data from any number of sources or data stores, such as data store 214 and data stores 216. Such data stores and data sources may include public data, private data, and/or the like.

The input data obtainer 230 may obtain any amount of data. For example, in some cases, an entire set of source examples may be obtained for identifying alternative examples in a batch manner. In another example, a single source example from which to generate an alternative example(s) may be obtained. The type and amount of data obtained by input data obtainer 230 may vary per implementation and is not intended to limit the scope of embodiments described herein.

The alternative example prompt generator 232 is generally configured to generate alternative example prompts, which may be performed in a similar manner as that described with respect to prompt generator 222. An alternative example prompt generally refers to a prompt used to generate an alternative example(s). Although illustrated as separate components, a single component or any other number of components may be used. As described herein, alternative example generator 234 may be in any number of forms, including various forms of machine learning models, such as a classifier(s), a generator(s), an LLM(s), and/or the like. As such, the alternative example prompt generated by the alternative example prompt generator 232 may be designed based on the technology used to identify or generate alternative examples.

An alternative example prompt generally refers to an input, such as a text input, that can be provided to alternative example generator 234, such as an LLM, to generate an output in the form of an alternative example. Generally, the alternative example prompt includes the source example for the content for which alternative examples are desired. In embodiments in which an LLM is used to identify or generate alternative examples, the alternative example prompt may include an alternative example instruction, a source example(s), and a set of user segments, among other things. An alternative example instruction generally refers to an instruction or request to generate one or more alternative examples. A source example generally refers to an example generated or identified in association with a particular content and usable to generate an alternative example. A user segment generally refers to an attribute or characteristic, or a set thereof, that is of interest or corresponds with a set of users. In this way, a user segment can group users into a segment, or cohort, based on a similar characteristic(s). A user segment is used herein to generate an alternative example. A user segment can be based on any aspect or characteristic. As one example, a user segment can be based on a topic or subject matter of interest. For example, topics may include fashion, sports, electronics, nature, technology, etc. In one embodiment, topics are identified or generated by accessing a list of categorized industries and scraping all possible industries. As another example, a user segment can be based on demographics, such as ethnicity, gender, or age. Other examples used for user segments include a geographical location, a device used, a behavior, a language preference, an interest, an industry, and/or the like. User segments may be a manually created list of items and sampled or accessed from audience segment data. By way of example only, an alternative example prompt may include an entity e[i], context c[i] associated with the entity, and topics of interest s, along with an instruction to generate m alternative examples. The topics of interest s may represent n attributes as s=s₁, s₂, . . . sₙ.

In addition, the alternative example prompt for an LLM may include output attributes. As described, output attributes generally indicate desired aspects associated with an output. By way of example, output attributes may include a number of alternative examples that may be identified for a content, a number of alternative examples that may be identified for a particular source example, a likelihood (e.g., probability) of an alternative example, and the like. For instance, assume a source example is provided as input for which to identify an alternative example(s). In such a case, output attributes may indicate to output a single, primary alternative example and a maximum of five secondary alternative examples. For instance, a primary alternative example may be identified for a source example, and two secondary alternative examples may be identified for the source example. As another example, an output attribute may indicate a target temperature to be associated with the output. As described, a temperature refers to a hyperparameter used to control the randomness of predictions. Generally, a low temperature makes the model more confident, while a higher temperature makes the model less confident. A temperature may be a default value, a value based on user input, or a determined value (e.g., based on a content attribute). As another example, an output attribute may indicate a target language for generating the output. For example, the source example may be provided in one language, and an output attribute may indicate to generate the alternative examples in another language. Any other instructions indicating a desired output are contemplated within embodiments of the present technology.

The alternative example prompt generator 232 may format the data in various forms or data structures. One example of a data structure for an alternative example prompt for an LLM is as follows:

{ Alternative Example Generation Request
{ Source example (Entity-Context Pair)
{ Set of User Segments.

One example of a prompt is “Given the entity [ENTITY HERE] within the context [CONTEXT HERE], generate five alternative entities that have appeared in a similar context. These alternatives should align with the specified [USER SEGMENT]. Additionally, provide a claim for each generated alternative entity, elucidating their experiences or circumstances comparable to the original entity. Please format the output as follows—Alternative Entity: Claim:”

As described, in embodiments, the alternative example prompt generator 232 generates or configures alternative example prompts in accordance with size constraints associated with a machine learning model, as described herein with respect to source example prompt generator 222. In embodiments, sample alternative examples (in some cases along with a correlated sample source example) are included in the prompt such that an LLM can learn from the samples to generate alternative examples.

The alternative example prompt generator 232 may generate any number of alternative example prompts. As one example, for alternative example prompts generated for a LLM, an alternative example prompt may be generated with a single source example and a particular set of user segments of interest. As yet another example, an alternative example prompt may be generated with multiple source examples for one or more user segments of interest.

The alternative example generator 234 is generally configured to generate alternative examples associated with a content, or a source example associated therewith. In this regard, the alternative example generator 234 utilizes a source example to identify one or more alternative examples associated with a particular content. In embodiments, the alternative example generator 234 can take, as input, an input prompt or set of input prompts generated by the alternative example prompt generator 232. Based on the alternative example prompt, the alternative example generator 234 can identify an alternative example(s) associated with a source example indicated in the alternative example prompt. For example, assume an alternative example prompt includes a source example generated for a particular content (e.g., article). In such a case, the alternative example generator 234 identifies an alternative example(s) associated with the content based on the source example included in the alternative source prompt.

As described, an alternative example generally refers to an example provided in a content different from the source content. In this regard, an alternative example is an alternative to, or different from, an example in an original source. Generally, the alternative example corresponds with the source example in a way that represents aspects similarly to the source example, but in a different context, domain, or user segment. An alternative example can be represented in any number of forms. In one embodiment, an alternative example includes an alternative entity and a claim, which may be referred to herein as an alternative entity-claim pair. In this regard, for a particular source example, an LLM can output an identified alternative entity and corresponding claim. An alternative entity generally refers to an entity that is alternative to the original entity in the source content. In embodiments, an alternative entity refers to an aspect that is, or could be, relevant to a particular user segment, that is different from a user segment associated with source content. A claim generally refers to a natural language assertion that corresponds with context in the source example. In this regard, a claim matches or corresponds with aspects of the source example included in the context, but in association with a different user segment.

The alternative example generator 234 may be or include any number or type of machine learning models or technologies. In some embodiments, the alternative example generator 234 includes a machine learning model in the form of an LLM. As such, as described herein, the alternative example generator 234, in the form of an LLM, can obtain the alternative example prompt and, using such information in the alternative example prompt, identify an alternative example or set of alternative examples for content. The alternative example generator 234 in the form of an LLM may generate any number of alternative examples in response to an alternative example prompt. As one example, assume an alternative example prompt includes one or more source examples associated with a particular content. In such a case, the source examples(s) can be used to identify any number of alternative examples for the content. In some cases, the number of alternative examples produced or generated can be based on the alternative example prompt. For instance, an alternative example prompt may indicate a target, maximum, or minimum number of alternative examples to generate. For example, a set of topics for which to generate alternative examples may be designated as well as a number of alternative examples associated with each topic (e.g., the alternative example prompt may specify that, for a particular source example, generate one alternative example for each specified topic, such as sports, leisure, food and drink, art, etc.). In another example, assume an alternative example prompt includes various source examples associated with a particular content. In such a case, the source examples can be used to identify any number of alternative examples for the particular content. Although the alternative example generator 234 is illustrated as separate from the source example identifier 224, in some cases, a same LLM is used to perform the functionalities described herein.

Any other type of models, algorithms, machine learning, and/or the like can be used by the alternative example generator 234 to identify alternative examples. Further, any number of technologies may be used. In some cases, the particular technology used may be based on desired technologies to implement, etc.

The alternative example verifier 236 is generally configured to verify alternative examples. In particular, the alternative example verifier 236 can ensure that the generated alternative example is contextually consistent with the source example. In this regard, the source and alternative examples generally should have the same or similar relevance to the content if replaced. In implementation, the alternative example verifier 236 can verify the factual accuracy and consistency of the model-generated alternative examples, thereby enhancing the reliability of the alternative examples.

In one embodiment, the alternative example verifier 236 provides the alternative example, or a portion thereof (e.g., a claim), to a search engine for performing a search. For example, an application programming interface (API) can be used to provide the alternative example to a search engine to generate search results in association with the alternative example, or a portion thereof. The alternative example verifier 236 can analyze the search results to determine whether the alternative example, or portion thereof, matches or corresponds with any such documents. For instance, the alternative example verifier 236 can extract a particular number of documents (e.g., twenty) provided in the search results. The documents can then be parsed and analyzed. In cases in which the alternative example, or claim associated therewith, matches or corresponds with a particular threshold number of documents (e.g., 50% of the documents), the alternative example is verified as accurate or appropriate. For instance, a determination can be made as to whether there is a sentence, or set of sentences, that match the alternative example (e.g., exceed a probability threshold), or claim associated therewith (e.g., in the form of a premise and hypothesis).

By way of example only, the alternative example verifier 236 may retrieve potential references for alternative examples, or claims associated therewith, from internet sources for each of the m named entities b₁, b₂, . . . bₘ in the alternative examples. This can be represented as:

$$D = [ {d}_{1 k} , {d}_{2 k} , … ] = Q ( {b}_{k} ) ,$$

wherein D represents reference documents from the search query engine Q that are relevant to the kth alternative example entity bₖ. These could potentially be references that can support the claim cₖ. To reduce computational intensity and overcome typical model limitations concerning input token length, each reference document can be segmented into smaller chunks and segments that are not semantically similar to the claim cₖ can be filtered out or removed. Such segmentation and filtering, as appropriate, eliminates irrelevant passages and reduces the volume of reference texts that need to be fact checked or verified. For example, F, as shown below, represents a filtering function that chunks documents and retains only those chunks Rₖ with a high cosine similarity with claim cₖ:

$${R}_{k} = F ( D , {c}_{k} )$$

To perform such verification, the alternative example verifier 236 may use a natural language inference (NLI) model. In embodiments, an NLI model can take a premise and a hypothesis as input and, in response, output an entailment probability. Generally, a NLI model determines if a hypothesis is true (entailment), false (contradiction), or undetermined (neutral), given a premise. If a hypothesis is true given a premise, it can be said that the hypothesis entails the premise (is consistent with the premise). Such models usually output probabilities for each of the three classes (entailment, contradiction, and neutral) given an input premise and hypothesis. In one implementation, the ROBERTALARGE model trained on the multi-genre natural language inference (MNLI) dataset is used.

As described, the NLI can be used to verify each claim cₖ against the filtered set of references Rₖ, checking if Rₖ contains any sentences that support cₖ. If there are at least r sentences in Fₖ that yield a high enough entailment probability when used as the premise, it is concluded that the claim cₖ is factually correct. For example, a verifier model V based on NLI can produce a set of supporting sentences Sₖ with which the claim cₖ can be verified to be factually correct, as follows:

$${S}_{k} = V ( {R}_{k} , {c}_{k} ) .$$

If the size of Sₖ is below a threshold r, it is concluded that the claim cₖ is factually incorrect.

In some embodiments, alternative examples are verified upon generation. In other embodiments, the alternative examples are stored and subsequently verified (e.g., as a batch at a later time).

In some cases, the alternative example verifier 236 may also be configured to obtain a human (e.g., marketer) approval prior to providing, presenting, or using the alternative examples. In this regard, alternative examples may be presented to a human for approving or disapproving the alternative examples. For instance, a human may review an alternative example for a content and approve the alternative example as appropriate. In some cases, the human may be associated with the content (e.g., a creator of the source content for which the alternative examples were generated). In other cases, the human may be independent from the content. Any number of humans may review, edit, and/or approve the alternative examples. As can be appreciated, verification of alternative examples may not be performed in some implementations, and various implementations may alter the scope of verification, depending on implementation preferences.

The alternative example provider 238 is generally configured to provide alternative examples. In this regard, upon identifying and/or verifying an alternative example, the alternative example provider 236 can provide such data, for example, for display via a device (e.g., user device). To this end, in cases in which the alternative example manager 218 is remote from the user device, the alternative example provider 236 may provide an alternative example(s) for display associated with initiating a request for an alternative example. In embodiments, an alternative example is generated and provided for display in real time. In this way, in response to an indication to identify an alternative example, an alternative example is identified and provided for display in real time.

Alternatively or additionally, alternative examples may be provided to a data store for storage or to another component or service, such as a content service. Such a component or service may then provide the alternative example(s) for display, for example, via a user device. For instance, as described herein, in some cases, alternative examples may be identified in a periodic or batch manner. As one example, alternative examples may be generated in off-hours (hours in which computing resources are more available and not used by other processes). Such identified alternative examples and corresponding content, or indications thereof, can then be stored, for example, in data store 214.

Alternative examples may be provided for display in any number of ways. In some examples, an alternative example is provided in accordance with the corresponding content and/or representation of the content (e.g., an icon, thumbnail, or link). In addition to the alternative examples, other information may be presented, such as a probability or likelihood associated with the alternative example. In some cases, the alternative example(s) and corresponding information are automatically displayed. In other cases, a user may select to view such information. For instance, a link may be presented that, if selected, presents alternative examples.

In embodiments, alternative examples are provided in association with a user segment of interest to the user. For example, assume a user is interested in the topic of sports. In such a case, the user may select a sports topic and be presented with the alternative example related to sports. In some cases, multiple user segment options are presented for selection by a user and, upon a user selection of one of the user segments, a corresponding alternative example(s) is presented for display. In other cases, a user segment of interest may be automatically determined based on a user. For example, assume a user is identified as having a particular topic of interest (e.g., using a user profile or historical user behavior). In such a case, in connection with presenting a content for display, an alternative example corresponding to the topic of interest may be identified and presented.

In addition or in the alternative to providing alternative examples for display, alternative examples can be provided for utilization, for example, to analyze content, to provide recommendations, and/or the like. In this regard, the alternative example provider 238 provides alternative examples and, in some cases, corresponding data (e.g., probabilities) for analysis. As one example, alternative examples, and corresponding information, may be provided to a content service, such as content service 118 of FIG. 1. The content service may automatically analyze the alternative examples, determine trends associated with the alternative examples, identify marketing or content search result approaches in association with alternative examples, etc., and provide results in association therewith (e.g., for display).

The feedback manager 240 is generally configured to obtain feedback associated with an alternative example(s). By capturing and analyzing user feedback on the alternative examples, a touch point is included that enhances the understanding of user segments. This insight can drive more effective re-engagement strategies and enriches overall marketing efforts.

In this regard, in accordance with presenting an alternative example, an option for providing feedback can also be presented. For example, thumbs up (to approve the example) and thumbs down (to reject the example) icons can be presented for receiving a user selection. As a user selects or provides input regarding relevance or interest of an alternative example, the feedback is captured via feedback manager 240. Such feedback can be used to update the understanding of the user (e.g., by updating the user profile). Additionally or alternatively, the feedback can facilitate understanding of various user segments over time. In some embodiments, techniques like reinforcement learning from human feedback (RLHF) can be used to improve segment understanding and train an LLM, or another machine learning model, to generate better source examples and/or alternative examples for various user segments.

### Exemplary Implementations for Efficiently Generating Alternative Examples for Content

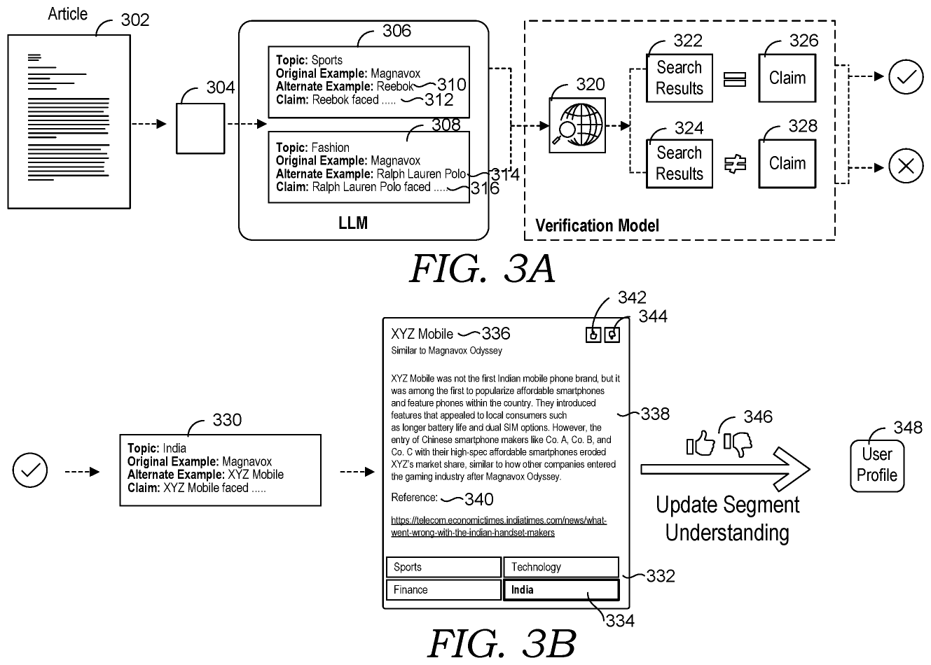

FIGS. 3A-3B provide an example implementation for generating and presenting alternative examples for content. With initial reference to FIG. 3A, assume an article 302 is obtained. Text content 304 is extracted from the article 302 and input into a large language model to generate a source example from the text content 304. The source example can include an entity and context associated therewith. The source example is then provided as input, along with a user segment(s), into the large language model to generate a set of alternative examples 306 and 308. In this way, the large language model can identify relevant entities for different topics of interest and generate claims for these entities. In this example, alternative example 306 is generated in association with the sports topic, and alternative example 308 is generated in association with the fashion topic. For alternative example 306 associated with the sports topic, the alternative entity “Reebok” 310 and the claim 312 are identified and used to represent the alternative example 306. For alternative example 308 associated with the fashion topic, the alternative entity “Ralph Lauren Polo” 314 and the claim 316 are identified and used to represent the alternative example 308.

In accordance with generating alternative examples 306 and 308, the alternative examples are verified, for example, using a verification model that verifies the facts corresponding to the alternative examples. In this example, the alternative examples 306 and 308, or portions associated therewith, are provided to a search engine 320 to generate search results 322 and 324, respectively. Search results 322 are analyzed in association with the claim 326 of the alternative example 306 to identify if the claim 326 matches the search results 322. Similarly, search results 324 are analyzed in association with the claim 328 of the alternative example 308 to identify if the claim 328 matches the search results 324. In some cases, a threshold proportion or number of search results matching the claim may be needed to verify the claim 326 is factually accurate. In this example, the claim 326 is identified as matching search results 322 and, as such, is verified as factually accurate. Accordingly, claim 326 and/or alternative example 308 can be provided for presentation, utilization, or human approval. On the other hand, claim 328 is identified as not matching search results 324 and, as such, is not verified as factually inaccurate. In this way, the claim 328 and/or the alternative example 308 is not provided for utilization or presentation.

Continuing with FIG. 3B, assume alternative example 330 is verified as factually accurate. In such a case, the alternative example 308, or portion thereof, can be provided for presentation. For example, assume a user views an article regarding Magnavox Odyssey. In accordance with presenting the article, a set of user segment options 332 is presented. Now assume the user is interested in the India user segment and selects the India user segment option 334. Based on the selection, the alternative example 308, or portion thereof, can be provided for display. In this example, the alternative entity 336 is presented along with the claim 338. In addition, a reference 340 may also be presented. The reference generally indicates a reference or source that supports the alternative example, or claim. For example, a reference may be a source from which the alternative example was generated, or it may be a source used to confirm factual accuracy of the claim. A reference may be in any number of formats, such as a link to the source. Feedback indicators 342 and 344 may also be presented to enable a reviewer to provide feedback related to the alternative example. For instance, a user may select the thumbs up indicator 342 to indicate a positive perception related to the alternative example or the thumbs down indicator 344 to indicate a negative perception related to the alternative example. Any input is provided as feedback 346 for use in updating a user profile 348 associated with the user. Alternatively or additionally, the feedback 346 can be used to update or enhance various aspects of technology described herein, such as generation of source examples, generation of alternative examples, etc.

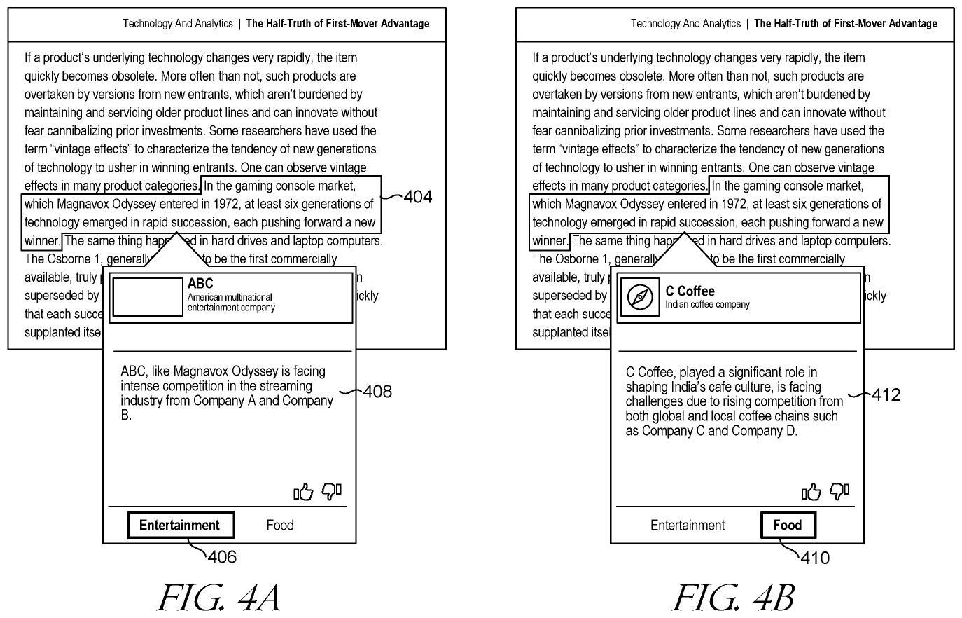

FIGS. 4A-4B provide examples of user interfaces associated with providing alternative examples. In FIGS. 4A-4B, the original content 402 is provided for display. Assume that based on providing content 402 to a large language model, a source example is identified. In this example, the source example can correspond with sentence 404 in the original content 402. For instance, sentence 404 may be identified as the context associated with the original content 402 for which alternative examples can be generated. Further assume that the source example is provided along with user interests of entertainment and food into the large language model to generate alternative examples. In some cases, the user interests may be selected based on attributes or characteristics of the user viewing original content 402. For instance, a user profile associated with the user viewing original content 402 may be accessed and used to identify that the user is interested in entertainment and food. Based on selection of the entertainment topic 406, the alternative example 408 associated with entertainment is provided for display. In some cases, user segment options may be presented based on interaction with the original content 402, such as hovering over text. In other cases, user segment options may be presented automatically or based on a user selection to view user segment options (e.g., via a menu selection). Now assume the user desires to view an example associated with food. In such a case, the user can select the food topic 410 to view alternative example 412.

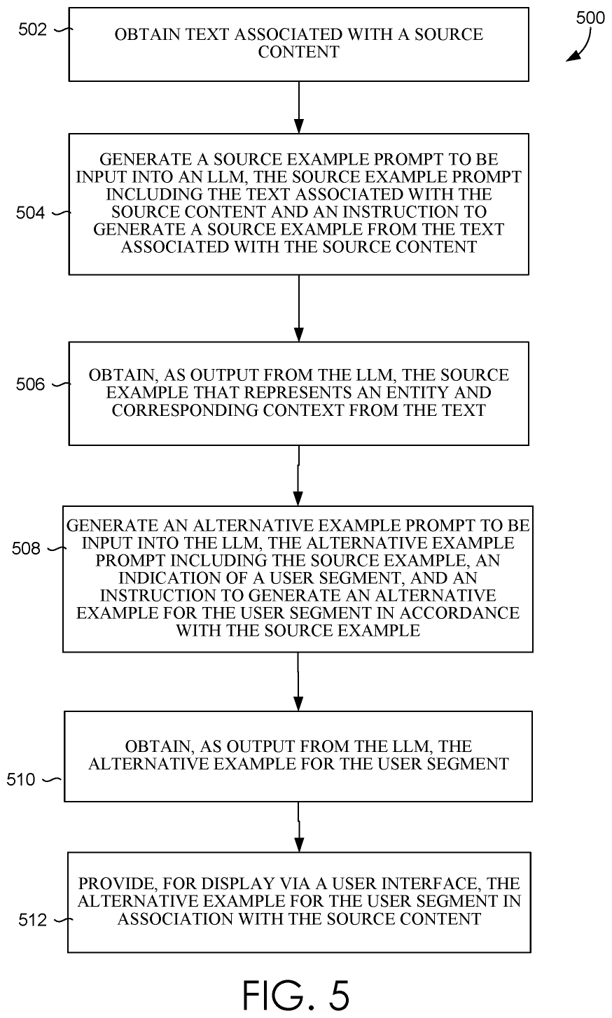

As described, various implementations can be used in accordance with embodiments described herein. FIGS. 5-7 provide methods of facilitating efficient generation of alternative examples for content, in accordance with embodiments described herein. Methods 500, 600, and 700 can be performed by a computer device, such as device 800 described below. The flow diagrams represented in FIGS. 5-7 are intended to be exemplary in nature and not limiting.

Turning initially to method 500 of FIG. 5, method 500 is directed to facilitating efficient generation of alternative examples for content, in accordance with embodiments of the present technology. Initially, at block 502, text associated with a source content is obtained. At block 504, a source example prompt to be input into a large language model is generated. In embodiments, the source example prompt includes the text associated with the source content and an instruction to generate a source example from the text associated with the source content. At block 506, the source example that represents an entity and corresponding context from the text is obtained as output from the large language model. At block 508, an alternative example prompt to be input into the large language model is generated. In embodiments, the alternative example prompt includes the source example, an indication of a user segment, and an instruction to generate an alternative example for the user segment in accordance with the source example. The user segment can be a topic, a demographic, or other interest, and is not intended to be limited herein.

At block 510, the alternative example for the user segment is obtained as output from the large language model. In embodiments, the alternative example includes an alternative entity different from the entity of the source example and a claim generated based on the context of the source example. At block 512, the alternative example for the user segment is provided, for display via a user interface, in association with the source content. In some cases, the alternative example is provided for display via the user interface by supplementing a presentation of the source content. In other cases, the alternative example is provided for display in response to a user selection of a user segment option representing the user segment. The alternative example can be provided for display by modifying the source content to include the alternative example or by supplementing the source content.

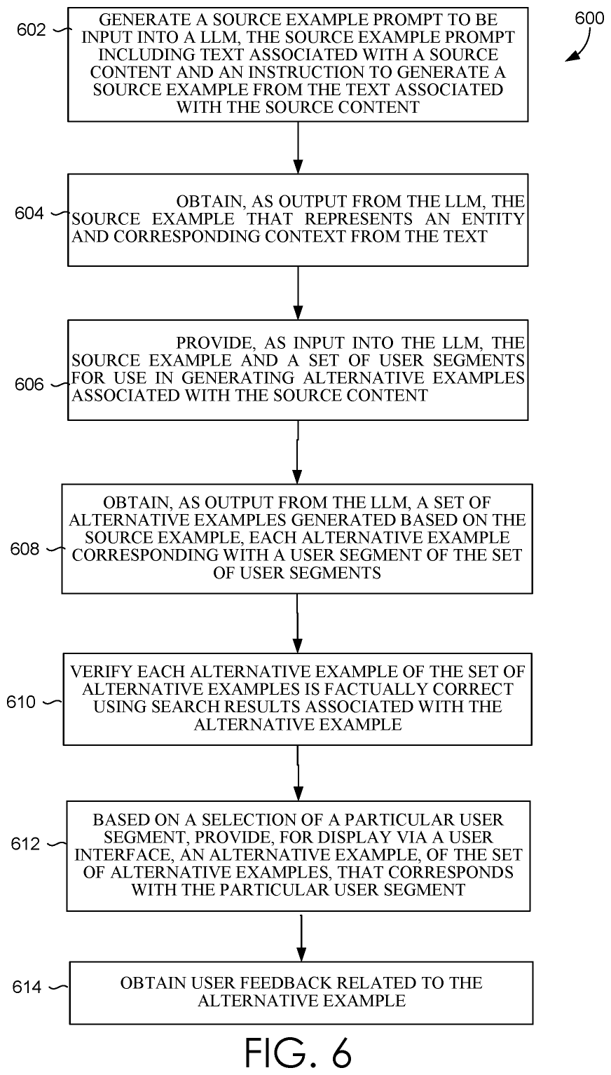

Turning to FIG. 6, FIG. 6 provides another illustrative example for generating alternative examples for content, in accordance with embodiments described herein. Initially, at block 602, a source example prompt to be input into a large language model is generated. In embodiments, the source example prompt includes text associated with a source content and an instruction to generate a source example from the text associated with the source content. At block 604, the source example that represents an entity and corresponding context from the text is obtained as output from the large language model. At block 606, the source example and a set of user segments for use in generating alternative examples associated with the source content are provided as input into the large language model. At block 608, a set of alternative examples generated based on the source example is obtained as output from the large language model. In embodiments, each alternative example corresponds with a user segment of the set of user segments. The alternative examples can include an alternative entity different from the entity of the source content and a claim that matches the context of the source content. At block 610, each alternative example of the set of alternative examples is verified as factually correct using search results associated with the alternative example. In some implementations, verification of the alternative example is performed by obtaining search results associated with the alternative example and, thereafter, determining that a threshold number of the search results match at least a portion of the alternative example.

At block 612, based on a selection of a particular user segment, an alternative example, of the set of alternative examples, that corresponds to the particular user segment is provided for display. In one embodiment, a particular user segment is selected from a set of displayed user segment options. In some cases, the alternative example is presented as a supplement to the source content. In other cases, the alternative example is presented by modifying the source content to include the alternative example. At block 614, user feedback related to the alternative example is obtained. In some cases, the user feedback is provided in response to a display of the alternative example and indicates an approval or a disapproval of the alternative example. The user feedback can be used, for example, to supplement or modify interests included in a user profile.

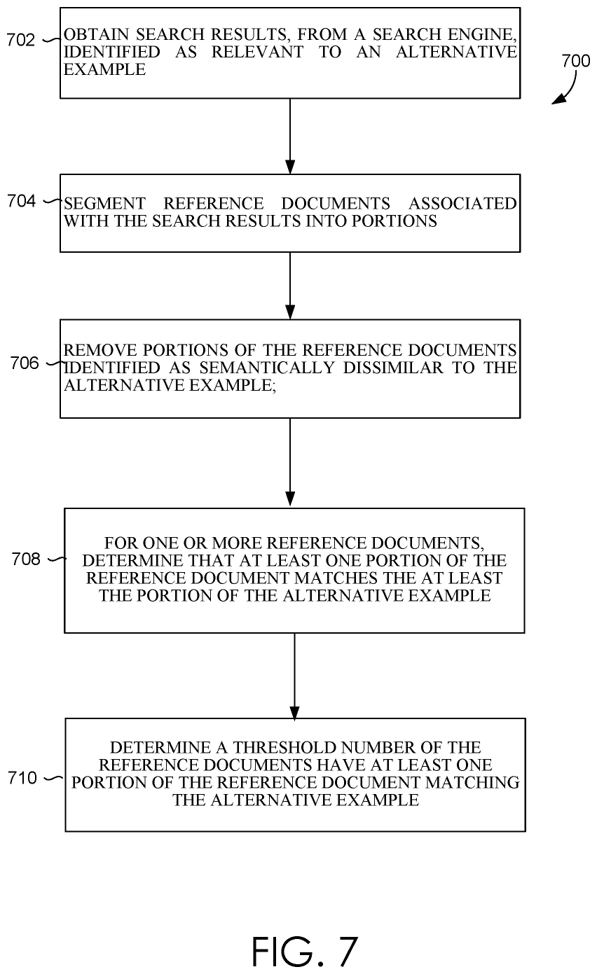

Turning now to FIG. 7, FIG. 7 provides an example implementation for performing verification of an alternative example, in accordance with embodiments of the present technology. Initially, at block 702, search results identified as relevant to an alternative example are obtained from a search engine. At block 704, reference documents associated with the search results are segmented into portions. At block 706, portions of the reference documents identified as semantically dissimilar to the alternative example are removed. Advantageously, removal of portions of reference documents enables for a more efficient verification analysis. At block 708, for one or more reference documents, a determination is made that at least one portion of the reference document matches the alternative example. At block 710, a threshold number of the reference documents are determined to have the at least one portion of the reference document matching the alternative example. In this way, the alternative example is verified as factually accurate.

Accordingly, we have described various aspects of technology directed to systems, methods, and graphical user interfaces for intelligently generating and providing alternative samples for content. It is understood that various features, sub-combinations, and modifications of the embodiments described herein are of utility and may be employed in other embodiments without reference to other features or sub-combinations. Moreover, the order and sequences of steps shown in the example methods 500, 600, and 700 are not meant to limit the scope of the present disclosure in any way, and in fact, the steps may occur in a variety of different sequences within embodiments hereof. Such variations and combinations thereof are also contemplated to be within the scope of embodiments of this disclosure.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 8 in particular, an exemplary operating environment for implementing aspects of the technology described herein is shown and designated generally as computing device 800. Computing device 800 is just one example of a suitable computing environment and is not intended to suggest any limitation as to the scope of use or functionality of the technology described herein. Neither should the computing device 800 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, an illustrative power supply 822, and a radio(s) 824. Bus 810 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 8 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or nonvolatile memory. The memory 812 may be removable, non-removable, or a combination thereof. Exemplary memory includes solid-state memory, hard drives, and optical-disc drives. Computing device 800 includes one or more processors 814 that read data from various entities such as bus 810, memory 812, or I/O components 820. Presentation component(s) 816 present data indications to a user or other device. Exemplary presentation components 816 include a display device, speaker, printing component, and vibrating component. I/O port(s) 818 allow computing device 800 to be logically coupled to other devices including I/O components 820, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 800. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include radio(s) 824. The radio 824 transmits and receives radio communications. The computing device may be a wireless terminal adapted to receive communications and media over various wireless networks. Computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. A computing system comprising:
a processor; and
computer storage memory having computer-executable instructions stored thereon which, when executed by the processor, configure the computing system to perform operations comprising:
obtain text associated with a source content;
generate a source example prompt to be input into a large language model, the source example prompt including the text associated with the source content and an instruction to generate a source example from the text associated with the source content;
obtain, as output from the large language model, the source example that represents an entity and corresponding context from the text;
generate an alternative example prompt to be input into the large language model, the alternative example prompt including the source example, an indication of a user segment, and an instruction to generate an alternative example for the user segment in accordance with the source example;
obtain, as output from the large language model, the alternative example for the user segment; and
provide, for display via a user interface, the alternative example for the user segment in association with the source content.

2. The computing system of claim 1, wherein the operations further comprise performing verification of the alternative example by:
obtaining search results associated with the alternative example; and
determining that a threshold number of the search results match at least a portion of the alternative example.

3. The computing system of claim 1, wherein the operations further comprise performing verification of the alternative example by:
obtaining search results, from a search engine, identified as relevant to a query, the query including at least a portion of the alternative example;
segmenting reference documents associated with the search results into portions;
removing portions of the reference documents identified as semantically dissimilar to the at least the portion of the alternative example;
for each reference document, determining if at least one portion of the reference document matches the at least the portion of the alternative example; and
identifying that a threshold number of the reference documents are determined to have the at least one portion of the reference document matching the at least the portion of the alternative example.

4. The computing system of claim 2, wherein the verification of the alternative example further comprises obtaining an input indicating the alternative example is accurate prior to providing the alternative example for display.

5. The computing system of claim 1, wherein the operations further comprise obtaining user feedback associated with the alternative example, wherein the user feedback is provided in response to a display of the alternative example and indicates an approval or a disapproval of the alternative example.

6. The computing system of claim 1, wherein the alternative example is provided for display via the user interface by supplementing a presentation of the source content.

7. The computing system of claim 6, wherein the alternative example is provided for display in response to a user selection of a user segment option representing the user segment.

8. The computing system of claim 1, wherein the alternative example is provided for display via the user interface by modifying the source content to include the alternative example.

9. The computing system of claim 1, wherein the alternative example comprises an alternative entity different from the entity of the source example and a claim generated based on the context of the source example.

10. The computing system of claim 1, wherein the user segment comprises at least one of a topic and a demographic.

11. A computer-implemented method comprising:
generating a source example prompt to be input into a large language model, the source example prompt including text associated with a source content and an instruction to generate a source example from the text associated with the source content;
obtaining, as output from the large language model, the source example that represents an entity and corresponding context from the text;
providing, as input into the large language model, the source example and a set of user segments for use in generating alternative examples associated with the source content;
obtaining, as output from the large language model, a set of alternative examples generated based on the source example, each alternative example corresponding to a user segment of the set of user segments;
verifying that each alternative example of the set of alternative examples is factually correct using search results associated with the alternative example; and
based on a selection of a particular user segment, providing, for display via a user interface, an alternative example, of the set of alternative examples, that corresponds to the particular user segment.

12. The method of claim 11 further comprising providing, for display via the user interface, a set of user segment options in association with the source content, the set of user segment options including an option of the particular user segment.

13. The method of claim 11, wherein the alternative example includes an alternative entity different from the entity of the source content and a claim that matches the context of the source content.

14. The method of claim 11 further comprising receiving user feedback associated with the alternative example, wherein the user feedback is provided in response to a display of the alternative example and indicates an approval or a disapproval of the alternative example.

15. The method of claim 14, wherein the user feedback is used to supplement or modify interests included in a user profile.

16. One or more computer storage media having computer-executable instructions embodied thereon that, when executed by one or more processors, cause the one or more processors to perform a method, the method comprising:
obtaining, at a large language model, a source example prompt including text associated with a source content and an instruction to generate a source example from the text associated with the source content;
generating, using the large language model, the source example that represents an entity and corresponding context from the text;
providing, as input into the large language model, the source example and a set of user segments to generate alternative examples associated with the source content, each alternative example corresponding to a user segment of the set of user segments; and
based on a particular user segment associated with a user interested in the source content, causing presentation of an alternative example corresponding to the particular user segment.

17. The media of claim 16, wherein the particular user segment is identified using a user profile associated with the user interested in the source content.

18. The media of claim 16, wherein the particular user segment is identified based on a user selection of the particular user segment among user segment options.

19. The media of claim 16, wherein the alternative example is presented as a supplement to the source content.

20. The media of claim 16, wherein the alternative example is presented by modifying the source content to include the alternative example.
